(19) United States
(12) Patent Application Publication
(10) Pub. No.: US 2024/0162530 A1
(43) Pub. Date: May 16, 2024

(54) Coolant Management System for Mobility Vehicle

(71) Applicants: Hyundai Motor Company, Seoul (KR); Kia Corporation, Seoul (KR)

(72) Inventors: Sang Shin Lee, Suwon-si (KR); Man Ju Oh, Yongin-si (KR); Ki Mok Kim, Busan (KR); Uk Il Yang, Yongin-si (KR)

(21) Appl. No.: 18/346,645

(22) Filed: Jul. 3, 2023

(30) Foreign Application Priority Data
Nov. 10, 2022 (KR) 10-2022-0149842

(51) Int. Cl. H01M 10/6568; B60H 1/00; H01M 10/613; H01M 10/615; H01M 10/625; H01M 10/63

(52) U.S. Cl. CPC H01M 10/6568; B60H 1/00278; B60H 1/00885; H01M 10/613; H01M 10/615; H01M 10/625; H01M 10/63; B60H 2001/00307; B60H 2001/00928; B60L 53/302

(57) ABSTRACT

An embodiment coolant management system for a mobility vehicle includes an inlet line and an outlet line configured to be connected to an external thermal management station and configured to selectively supply a cooling or heating coolant, a refrigerant circuit that circulates a refrigerant therethrough, the refrigerant circuit including a compressor, a condenser, an expander, and an evaporator, a first coolant line that circulates a coolant therethrough, wherein a battery and a first heat exchanger that exchanges heat with the evaporator of the refrigerant circuit are provided on the first coolant line, a second coolant line configured to circulate the coolant therethrough, wherein a second heat exchanger that exchanges heat with the condenser of the refrigerant circuit is provided on the second coolant line, and a controller that communicates with the external thermal management station and control respective valves to manage a temperature of the coolant.

### CROSS-REFERENCE TO RELATED APPLICATIONS

This application claims the benefit of Korean Patent Application No. 10-2022-0149842, filed on Nov. 10, 2022, which application is hereby incorporated herein by reference.

### TECHNICAL FIELD

The present invention relates generally to a coolant management system for a mobility vehicle.

### BACKGROUND

Recently, development of technologies related to electric vehicles has been actively undertaken. In particular, in electric vehicles, technologies for thermal management of a battery have come into prominence. The battery serving as a key component like the engine of a conventional internal combustion engine (ICE) vehicle is more sensitive to the temperature than the engine. When the battery is overheated, the battery is vulnerable to damage due to the deterioration and the power efficiency thereof is significantly lowered. Thus, for efficiency thermal management of the battery, electric vehicles are provided with a battery coolant line.

In addition, not only when a vehicle is being driven using power from the battery but also when the battery is being charged, heat is generated. In particular, in high-speed charging of the battery, more heat may be generated, thereby deteriorating the battery or reducing the charging efficiency of the battery. Furthermore, when the ambient temperature is low, the charging efficiency of the battery may be reduced.

Accordingly, there has been demand for development of a coolant circulating system for a vehicle, the system being configured to be connected to a stopped electric vehicle in a specific situation, such as charging of the battery, to exchange coolant through a coolant line and cool or heat the coolant so as to improve the charging efficiency, the thermal efficiency, or the like of the battery.

The foregoing is intended merely to aid in the understanding of the background of embodiments of the present invention and is not intended to mean that embodiments of the present invention fall within the purview of the related art that is already known to those skilled in the art.

### SUMMARY

The present invention relates generally to a coolant management system for a mobility vehicle. Particular embodiments relate to a coolant management system enabling coolant managed outside an electric vehicle to be shared with coolant circulating through a battery provided in the electric vehicle for the purpose of thermal management of the battery of the electric vehicle.

Accordingly, embodiments of the present invention consider problems occurring in the related art and provide a coolant management system for a mobility vehicle, the coolant management system enabling coolant managed outside an electric vehicle to be shared with coolant circulating through a battery provided in the electric vehicle for thermal management of the battery of the electric vehicle, thereby improving charging efficiency of the battery through temperature management of the battery when charging the battery.

According to one embodiment of the present invention, there is provided a coolant management system for a mobility vehicle. The coolant management system may include an inlet line and an outlet line connected to an external thermal management station provided to selectively supply cooling coolant or heating coolant, a refrigerant circuit provided in a mobility vehicle, configured such that refrigerant circulates therethrough, and including a compressor, a condenser, an expander, and an evaporator, a first coolant line configured such that coolant circulates therethrough, with a first heat exchanger configured to exchange heat with the evaporator of the refrigerant circuit and a battery being provided on the first coolant line, and with the inlet line being connected to the front end of the battery through a first valve and the outlet line being connected to the rear end of the battery, a second coolant line configured such that coolant circulates therethrough, with a second heat exchanger configured to exchange heat with the condenser of the refrigerant circuit being provided on the second coolant line and with the outlet line and the first coolant line being connected to the front end of the second heat exchanger and the first coolant line being connected to the rear end of the second heat exchanger through the first valve, and a controller configured to communicate with the external thermal management station and control respective valves to manage the temperature of the coolant.

The coolant management system may further include a first water pump provided on the first coolant line and a second water pump provided on the second coolant line.

The coolant management system may further include a coolant heater on the second coolant line.

On/off valves may be provided on the inlet line and the outlet line, respectively, each of the on/off valves being on/off controlled by the controller.

The coolant management system may further include a third coolant line branched from a front end and a rear end of the second heat exchanger and connected to the second coolant line through a second valve. A radiator may be provided on the third coolant line.

The coolant management system may further include a fourth coolant line branched from a front end and a rear end of the first heat exchanger and connected to the first coolant line. An electronic component, a first exterior heat exchanger, and a third water pump may be provided on the fourth coolant line.

The fourth coolant line may be disposed such that the electronic component and the first exterior heat exchanger are branched, and a third valve may be provided at a branch point.

The coolant management system may further include a cooling line branched from a first heat exchanger of the first coolant line and connected to the first coolant line through a first flow rate control valve, with a cold core being provided on the cooling line.

The coolant management system may further include a fifth coolant line branched from a front end and a rear end of the first heat exchanger and connected to the first coolant line through a fourth valve. A second exterior heat exchanger and a fourth water pump may be provided on the fifth coolant line.

The coolant management system may further include a heating line branched from a front end and a rear end of the second heat exchanger and connected to a second coolant by a second flow rate control valve. A heater core may be provided on the heating line.

In a situation in which the mobility vehicle and the external thermal management station are connected, in a case of cooling or heating an interior of the vehicle, the controller may cause cooling coolant or heating coolant having entered through the inlet line to flow through the heater core and cause coolant having passed through the heater core to circulate to the external thermal management station through the outlet line by controlling the first valve.

In a case of cooling the battery, the controller may cause a refrigerant to circulate through the refrigerant circuit by driving the compressor and cause coolant cooled through the first heat exchanger and cooling coolant having entered through the inlet line to flow through the battery by controlling the first valve.

In the case of cooling the battery in a situation in which the mobility vehicle and the external thermal management station are connected, the controller may cause coolant having entered through the inlet line to flow through the battery by controlling the first valve and cause coolant having passed through the battery to circulate to the external thermal management station through the outlet line.

In a case of cooling the battery, the controller may cause a refrigerant to circulate through the refrigerant circuit by driving the compressor and cause coolant cooled through the first heat exchanger and cooling coolant having entered through the inlet line to flow through the battery by controlling the first valve.

In a case of heating the battery, the controller may cause a refrigerant to circulate through the refrigerant circuit by driving the compressor and cause coolant heated through the second heat exchanger to flow through the battery by controlling the first valve.

In a case of heating the battery in a situation in which the mobility vehicle and the external thermal management station are connected, the controller may cause heating coolant having entered through the inlet line to flow through the battery by controlling the first valve and cause coolant having passed through the battery to circulate to the external thermal management station through the outlet line.

In a case of heating the battery, the controller may cause a refrigerant to circulate through the refrigerant circuit by driving the compressor and cause coolant heated through the second heat exchanger and heating coolant having entered through the inlet line to flow through the battery by controlling the first valve.

The external thermal management station may include a first storage tank in which heating coolant is stored, a second storage tank in which cooling coolant is stored, a thermal management circuit including a thermal management compressor, a thermal management condenser disposed inside the first storage tank, a thermal management expander, and a thermal management evaporator disposed inside the second storage tank, and the inlet line and the outlet line extending from the first storage tank and the second storage tank, respectively, and provided with on/off valves, respectively.

An additional condenser may further be provided on the thermal management circuit between the thermal management compressor and the thermal management condenser, such that refrigerant flows through the additional condenser depending on opening/closing of an additional valve.

The coolant management system for a mobility vehicle having the above-described structure may cause coolant managed outside an electric vehicle to be shared with coolant circulating through the battery provided in the electric vehicle for thermal management of the battery of the electric vehicle, thereby improving charging efficiency of the battery through temperature management of the battery when charging the battery. That is, it is possible to optimize temperature management of the battery according to the situation by efficient management of coolant circulating through the battery and coolant managed outside the vehicle.

In addition, since it is possible to perform cooling or heating to the interior of the vehicle using coolant managed outside the vehicle, the efficiency of air conditioning energy of the mobility vehicle may be obtained.

### BRIEF DESCRIPTION OF THE DRAWINGS

The above and other objectives, features, and other advantages of embodiments of the present invention will be more clearly understood from the following detailed description when taken in conjunction with the accompanying drawings, in which:

FIG. 1 is a diagram illustrating a coolant management system for a mobility vehicle according to embodiments of the present invention;

FIG. 2 is a configuration diagram of the coolant management system for a mobility vehicle illustrated in FIG. 1;

FIG. 3 is a diagram illustrating an example in which the coolant management system for a mobility vehicle illustrated in FIG. 1 cools or heats the interior of the vehicle using an external thermal management station;

FIG. 4 is a diagram illustrating an example in which the coolant management system for a mobility vehicle illustrated in FIG. 1 cools a battery;

FIG. 5 is a diagram illustrating an example in which the coolant management system for a mobility vehicle illustrated in FIG. 1 cools the battery using the external thermal management station;

FIG. 6 is a diagram illustrating an example resulting from the cooling of the battery by the coolant management system for a mobility vehicle illustrated in FIG. 1;

FIG. 7 is a diagram illustrating an example in which the coolant management system for a mobility vehicle illustrated in FIG. 1 heats the battery;

FIG. 8 is a diagram illustrating an example resulting from the heating of the battery by the coolant management system for a mobility vehicle illustrated in FIG. 1; and

FIG. 9 is a diagram illustrating the external thermal management station according to embodiments of the present invention.

### DETAILED DESCRIPTION OF ILLUSTRATIVE EMBODIMENTS

Hereinafter, embodiments described in the present disclosure will be described in detail with reference to the accompanying drawings, in which identical or similar constituent elements are given the same reference numerals, and a repeated description thereof will be omitted.

Terms “module” and “part” used in the following description are given or interchanged only considering the ease of creating the specification and have no meanings or roles that are distinguished from each other by themselves.

In the description of embodiments of the present invention, when it is determined that the detailed description of the related art would obscure the gist of the present invention, the detailed description thereof will be omitted. In addition, the attached drawings are merely intended to be able to readily understand the embodiments disclosed herein, and thus the technical idea disclosed herein is not limited by the attached drawings, and it should be understood to include all changes, equivalents, and substitutions included in the idea and technical scope of the present invention.

It will be understood that, although terms “first,” “second,” etc., may be used herein to describe various elements, these elements should not be limited by these terms. These terms are only used to distinguish one element from another element.

It will be understood that when an element is referred to as being “coupled,” “connected,” or “linked” to another element, it can be directly coupled or connected to the other element or intervening elements may be present therebetween. In contrast, it should be understood that when an element is referred to as being “directly coupled,” “directly connected,” or “directly linked” to another element, there are no intervening elements present.

As used herein, singular forms “a,” “an,” and “the” are intended to include the plural forms as well, unless the context clearly indicates otherwise.

It will be further understood that terms “comprise”, “include”, “have”, etc., when used in this specification, specify the presence of stated features, integers, steps, operations, elements, components, and/or combinations thereof but do not preclude the presence or addition of one or more other features, integers, steps, operations, elements, components, and/or combinations thereof.

Herein, a controller may include a communication device communicating with another controller or a sensor in order to control a function which the controller manages, a memory storing an operating system, logic instructions, input/output information, and the like, and one or more processors performing determination, calculation, decision, and the like necessary for controlling the function.

In this context, a mobility vehicle includes any motorized vehicle, including a motorized micromobility vehicle, a personal mobility device, a personal transporter, a powered transporter, an electric rideable, a personal light electric vehicle, or any compact device for transporting an individual. Examples include electric skateboards, kick scooters, self-balancing unicycles (e.g., Segways™), motorized scooters or skateboards, electric bicycles, and electric motorbikes.

Hereinafter, a coolant management system for a mobility vehicle according to exemplary embodiments of the present invention will be described with reference to the accompanying drawings.

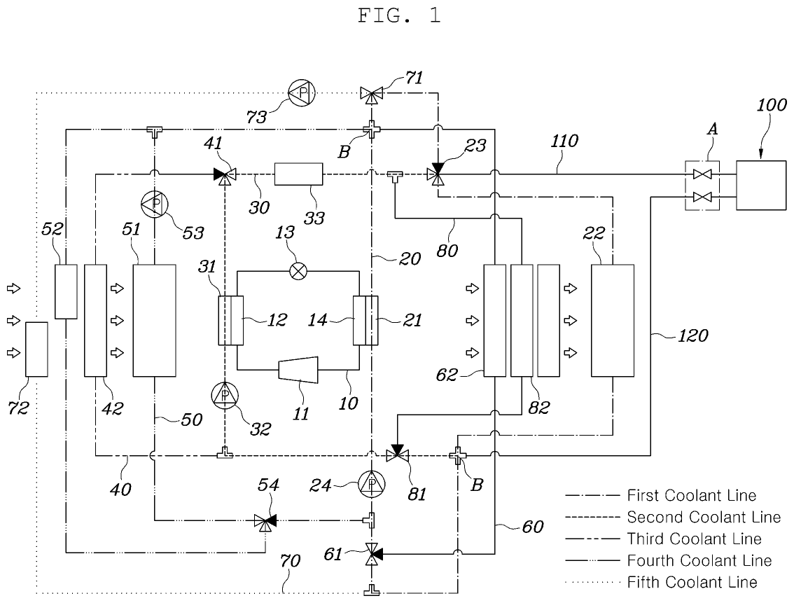

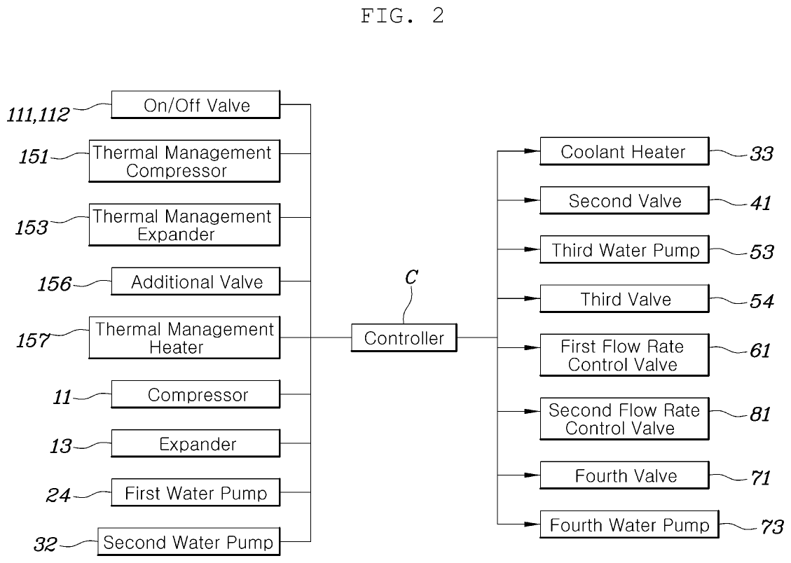

FIG. 1 is a diagram illustrating a coolant management system for a mobility vehicle according to embodiments of the present invention, and FIG. 2 is a configuration diagram of the coolant management system for a mobility vehicle illustrated in FIG. 1.

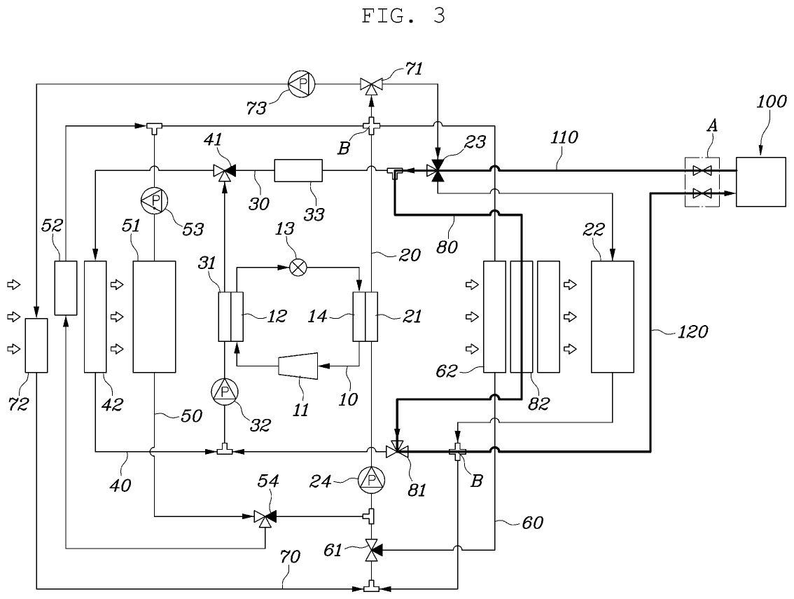

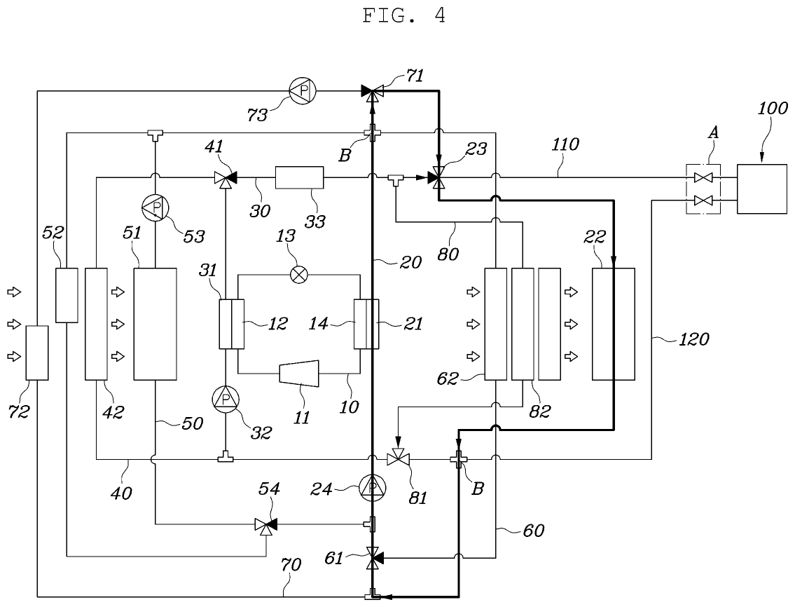

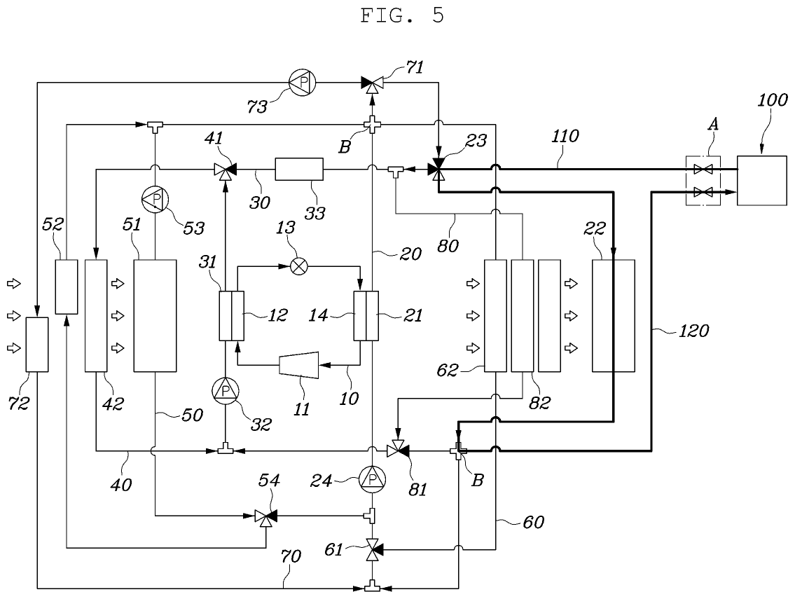

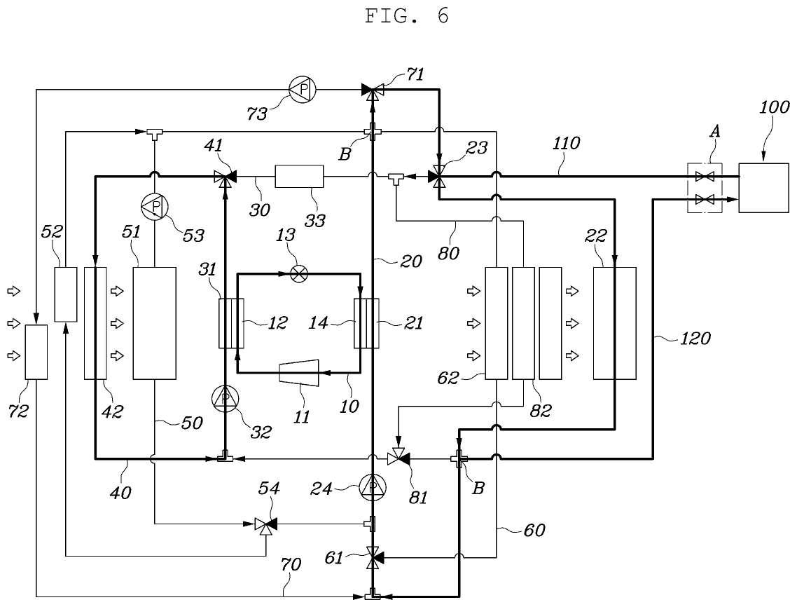

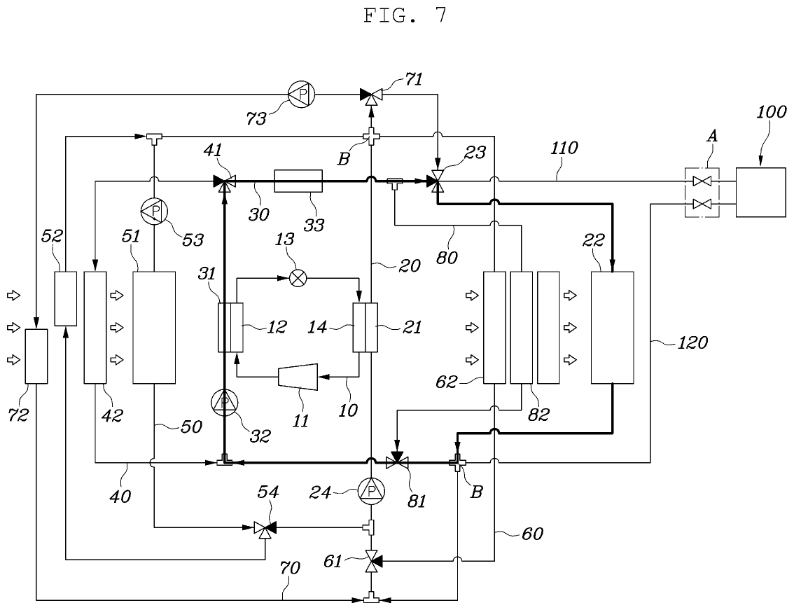

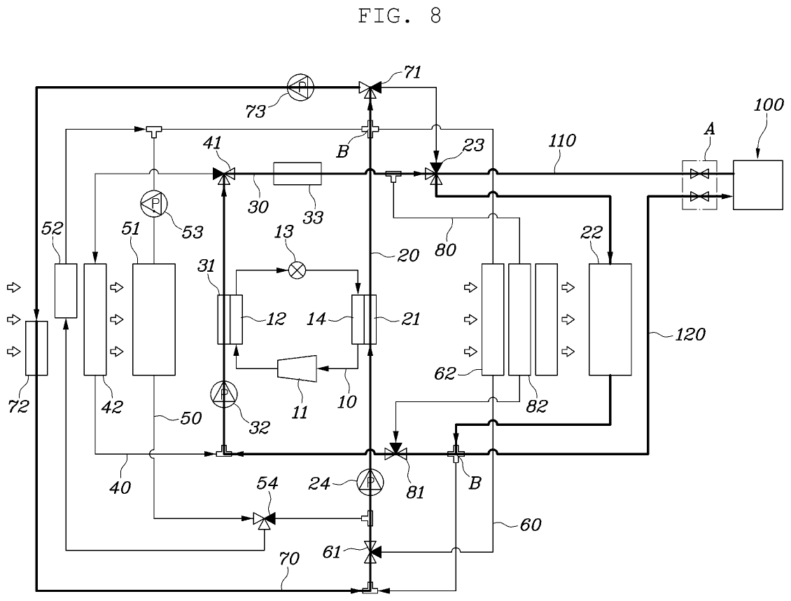

FIG. 3 is a diagram illustrating an example in which the coolant management system for a mobility vehicle illustrated in FIG. 1 cools or heats the interior of the vehicle using an external thermal management station, FIG. 4 is a diagram illustrating an example in which the coolant management system for a mobility vehicle illustrated in FIG. 1 cools a battery, FIG. 5 is a diagram illustrating an example in which the coolant management system for a mobility vehicle illustrated in FIG. 1 cools the battery using the external thermal management station, FIG. 6 is a diagram illustrating an example resulting from the cooling of the battery by the coolant management system for a mobility vehicle illustrated in FIG. 1, FIG. 7 is a diagram illustrating an example in which the coolant management system for a mobility vehicle illustrated in FIG. 1 heats the battery, and FIG. 8 is a diagram illustrating an example resulting from the heating of the battery by the coolant management system for a mobility vehicle illustrated in FIG. 1.

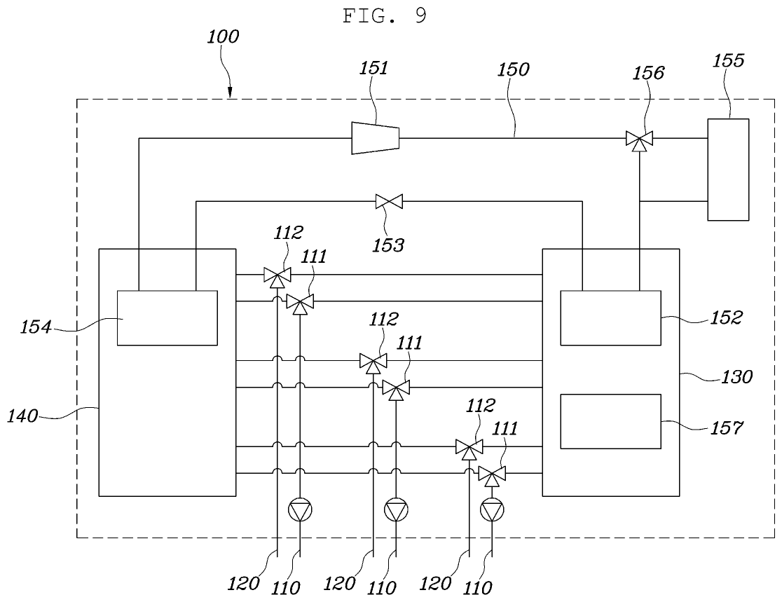

In addition, FIG. 9 is a diagram illustrating the external thermal management station according to embodiments of the present invention.

As illustrated in FIGS. 1 and 2, the coolant management system for a mobility vehicle according to embodiments of the present invention includes an inlet line no and an outlet line 120 connected to an external thermal management station 100 provided to selectively supply cooling coolant or heating coolant, a refrigerant circuit 10 provided in a mobility vehicle, configured such that refrigerant circulates therethrough, and including a compressor 11, a condenser 12, an expander 13, and an evaporator 14, a first coolant line 20 configured such that coolant circulates therethrough, with a first heat exchanger 21 configured to exchange heat with the evaporator 14 of the refrigerant circuit 10 and a battery 22 being provided on the first coolant line 20 and with the inlet line no being connected to the front end of the battery 22 through a first valve 23 and the outlet line 120 being connected to the rear end of the battery 22, a second coolant line 30 configured such that coolant circulates therethrough, with a second heat exchanger 31 configured to exchange heat with the condenser 12 of the refrigerant circuit 10 being provided on the second coolant line 30, and with the outlet line 120 and the first coolant line 20 being connected to the front end of the second heat exchanger 31 and the first coolant line 20 being connected to the rear end of the second heat exchanger 31 through the first valve 23, and a controller C configured to communicate with the external thermal management station 100 and control respective valves to manage the temperature of coolant.

In an electric vehicle, the battery is charged with power through a fast charger provided outside the vehicle. Here, the battery 22 may be a high voltage battery. In electric vehicles, reduced fast charging time is very important for salability. In fast charging, it is not possible to increase the amount of charge current unless the battery 22 is heated to a predetermined temperature or higher. Once the battery 22 has reached the predetermined temperature or higher, the temperature of the battery 22 will increase due to self-heating of the battery 22, and thus fast cooling is required. In this regard, the vehicle is required to be provided with a heater and a compressor each having a large capacity to heat and cool the battery 22. It is not desirable to provide the heater and the compressor inside the vehicle in consideration of limited capacity and cost reduction demand. The heater and the compressor are mounted on the vehicle for the charging function but apply a heavy load to the vehicle, thereby disadvantageously having an adverse effect to fuel efficiency.

In this regard, the coolant management system for a mobility vehicle according to embodiments of the present invention is configured to provide coolant management to the vehicle according to the environment inside and outside the vehicle by supplying cooled or heated coolant to the vehicle through the external thermal management station wo while the battery 22 of the vehicle is being charged. In cold conditions, the coolant management system heats the battery 22 at an early stage of an operation of charging the battery 22 in order to improve charging efficiency and, after the battery 22 is sufficiently heated, cools the battery 22 so that the temperature of the battery 22 does not further increase. In hot conditions, the coolant management system cools the battery 22 in order to improve charging efficiency and prevent the battery 22 from being overheated.

At the same time, embodiments of the present invention may obtain the degree of freedom of distribution of cooling coolant and heating coolant provided by the external thermal management station. In this manner, it is possible to perform air conditioning to the interior using the coolant provided by the external thermal management station. In addition, heat capacity that would otherwise be insufficient during cooling or heating of the battery 22 may be obtained and temperature management may be reliably performed.

The external thermal management station 100 may include a first storage tank 130 in which heating coolant is stored, a second storage tank 140 in which cooling coolant is stored, and a thermal management circuit 150 including a thermal management compressor 151, a thermal management condenser 152 disposed inside the first storage tank 130, a thermal management expander 153, and a thermal management evaporator 154 disposed inside the second storage tank 140.

Referring to FIG. 9, the external thermal management station 100 includes the first storage tank 130 and the second storage tank 140 in which different temperatures of coolant are managed.

In addition, the external thermal management station 100 includes the thermal management circuit 150 including the thermal management compressor 151, the thermal management condenser 152, the thermal management expander 153, and the thermal management evaporator 154 in order to adjust the temperature of the refrigerant. Here, the thermal management condenser 152 is disposed inside the first storage tank 130, and the thermal management evaporator 154 is disposed inside the second storage tank 140. Thus, when the thermal management condenser 152 dissipates heat, coolant within the first storage tank 130 is heated. When the thermal management evaporator 154 absorbs heat, coolant within the second storage tank 140 may be cooled. In addition, the first storage tank 130 may be further provided with a thermal management heater 157 to compensate for a heat source that is insufficient when only the thermal management condenser 152 is used.

In this manner, the inlet line no and the outlet line 120 may extend from the first storage tank 130 and the second storage tank 140, respectively, so as to be connected to the mobility vehicle. Flow of coolant is selectively controlled by the on/off valves in and 121 provided on the inlet line no and the outlet line 120.

In addition, the thermal management circuit 150 is further provided with an additional condenser 155 between the thermal management compressor 151 and the thermal management condenser 152. Refrigerant may flow through the additional condenser 155 depending on opening/closing of an additional valve 156.

The additional condenser 155 serves to manage the temperature of the refrigerant by exchanging heat with another external thermal exchange medium. The additional condenser 155 may be configured to exchange heat with the ambient air. The additional condenser 155 may be provided between the thermal management compressor 151 and the thermal management condenser 152. Refrigerant flows through the additional condenser 155 depending on opening/closing of the additional valve 156.

The coolant management system for a mobility vehicle according to an embodiment of the present invention includes the inlet line no and the outlet line 120 through which coolant provided by the external thermal management station 100 flows, the refrigerant circuit 10 provided inside the vehicle and configured such that the refrigerant circulates therethrough, and the first coolant line 20 and the second coolant line 30 provided inside the vehicle and configured such that coolant circulates therethrough. Here, the controller C controls directions of flow of the refrigerant and the coolant circulating through the refrigerant circuit 10 and through the first coolant line 20 and the second coolant line 30, respectively, so that the temperature of the coolant may be optimally managed according to respective situations.

The controller C is configured to receive information regarding cooling of the battery 22 and information regarding air conditioning by communicating with the vehicle and to be selectively supplied with cooling coolant and heating coolant by communicating with the external thermal management station 100.

Thus, the controller C may control the temperature of the coolant depending on the temperature of the battery 22 of the vehicle or the air conditioning of the vehicle. That is, the controller C may determine the temperature of the coolant flowing through each of the coolant circuits by receiving the temperature of the mobility vehicle after the initial intake of the coolant, the initial temperature of the coolant, the ambient temperature of the vehicle, and information regarding the state of charge (SOC) of the battery and may circulate coolant cooled or heated in this manner through the battery 22, thereby improving the charging efficiency of the battery 22.

Specifically describing embodiments of the present invention, the refrigerant circuit 10 is provided inside the mobility vehicle such that refrigerant circulates through the refrigerant circuit 10, and the first coolant line 20 and second coolant line 30 are configured such that coolant circulates therethrough. Here, refrigerant circulating through the refrigerant circuit 10 exchanges heat with coolant circulating through the first coolant line 20 and the second coolant line 30, thereby causing the temperature of the coolant to be adjusted.

The external thermal management station 100 may be provided with a connector A connected to the mobility vehicle, in addition to the fast charger. When the connector A is connected to the mobility vehicle, cooling coolant or heating coolant may be provided to the first coolant line 20 and the second coolant line 30 through the inlet line no and the outlet line 120. Here, the inlet line no and the outlet line 120 may be provided with the on/off valves in and 121, respectively, which are on/off controlled by the controller C. Thus, cooling coolant or heating coolant may be selectively supplied.

Describing the flow of refrigerant and coolant circulating inside the mobility vehicle, in the refrigerant circuit 10 including the compressor 11, the condenser 12, the expander 13, and the evaporator 14, the condenser 12 may dissipate heat and the evaporator 14 may absorb heat in response to the flow of the refrigerant, thereby adjusting the temperature of the coolant.

The first heat exchanger 21, configured to exchange heat with the evaporator 14, and the battery 22 are provided on the first coolant line 20, and the first coolant line 20 is connected to the inlet line no through the first valve 23. Here, a first water pump 24 may further be provided on the first coolant line 20 such that coolant may flow in response to the operation of the first water pump 24. In addition, although the first valve 23 is illustrated as a three-way valve since the first valve 23 is connected to the first coolant line 20, the second coolant line 30, and a fifth coolant line 70 to be described later, the first valve 23 may be implemented as a four-way valve such that the flow of the coolant toward or through the inlet line no may also be controlled.

That is, since the first coolant line 20 is provided with the first heat exchanger 21, the coolant may be cooled by heat exchange between the refrigerant and the coolant in the evaporator 14. In addition, depending on the direction of opening/closing of the first valve 23, the coolant that has passed through the first heat exchanger 21 may flow through the battery 22, the coolant provided by the external thermal management station 100 may flow through the battery 22, or both the coolant that has passed through the first heat exchanger 21 and the coolant provided by the external thermal management station 100 may simultaneously flow through the battery 22.

The second heat exchanger 31 exchanging heat with the condenser 12 is provided on the second coolant line 30, and the outlet line 120 is connected to the second coolant line 30. Here, a second water pump 32 is further provided on the second coolant line 30. Thus, the coolant may circulate in response to the operation of the second water pump 32. In addition, one more coolant heater 33 may be provided on the second coolant line 30 to compensate for a heat source that is insufficient when only the condenser 12 is used.

That is, since the second heat exchanger 31 is provided on the second coolant line 30, the coolant may be heated by heat exchange between the refrigerant and the coolant in the condenser 12. The coolant heated in this manner may be selectively supplied to the battery 22 depending on the direction of opening/closing of the first valve 23.

In addition, the inlet line no of the external thermal management station 100 may be connected to the first valve 23, and the outlet line 120 may be connected to the first coolant line 20 and the second coolant line 30 through a branched pipe B.

In this manner, in embodiments of the present invention, the temperature of the battery 22 may be managed by cooling or heating the coolant to the battery 22 by performing heat exchange between the refrigerant circulating through the refrigerant circuit 10 and the coolant circulating through each of the coolant circuits through the first heat exchanger 21 or the second heat exchanger 31.

In addition, while the temperature of the coolant may be managed by the mobility vehicle, the coolant supplied by the external thermal management station 100 may be immediately supplied to the battery 22, thereby improving the degree of freedom of distribution of the coolant flowing through the battery 22.

A third coolant line 40 branched from the front end and the rear end of the second heat exchanger 31 and connected to the second coolant line 30 through a second valve 41 may further be provided. A radiator 42 may be provided on the third coolant line 40.

As described above, the third coolant line 40 is branched from the second coolant line 30. The coolant circulating through the second coolant line 30 may selectively flow through the third coolant line 40 depending on opening/closing of the second valve 41. The third coolant line 40 may be configured to be branched from the rear end of the second heat exchanger 31 through the second valve 41 and connected to the front end of the second heat exchanger 31.

In addition, since the radiator 42 is provided on the third coolant line 40, the temperature of the coolant may be adjusted by causing heat exchange between the coolant and the ambient air through the radiator 42.

In addition, a fourth coolant line 50 branched from the front end and the rear end of the first heat exchanger 21 and connected to the first coolant line 20 may further be provided. An electronic component 51, a first exterior heat exchanger 52, and a third water pump 53 are provided on the fourth coolant line 50. The electronic component 51 and the first exterior heat exchanger 52 are disposed in parallel, and a third valve 54 may be provided at a branch point.

That is, the fourth coolant line 50 is branched from the first coolant line 20. The coolant circulating through the first coolant line 20 may selectively flow through the fourth coolant line 50 depending on opening/closing of the third valve 54. In addition, since the third water pump 53 is provided, the coolant may properly flow within the fourth coolant line 50 in response to the operation of the third water pump 53.

Here, the third valve 54 is configured to control whether or not the coolant flowing through the first coolant line 20 flows through the fourth coolant line 50. The third valve 54 is also configured to selectively allow the coolant that has flowed through the first coolant line 20 to flow through the electronic component 51 or the first exterior heat exchanger 52. In this manner, when the coolant flows through the electronic component 51, the electronic component 51 may be cooled. When the coolant flows through the first exterior heat exchanger 52, the coolant may exchange heat with the ambient air in the first exterior heat exchanger 52, so that the temperature of the coolant may be adjusted.

In addition, a cooling line 60 branched from the first heat exchanger 21 of the first coolant line 20 and connected to the first coolant line 20 through a first flow rate control valve 61 is further included. A cold core 62 may be provided on the cooling line 60.

The cooling line 60 is provided for air conditioning of the interior. Air supplied to the interior may exchange heat with the coolant through the cold core 62, thereby cooling the coolant.

The cooling line 60 may be configured to be branched from the rear end of the first heat exchanger 21 of the first coolant line 20 at a branch point of the fourth coolant line 50 and connected to the front end of the first heat exchanger 21 through the first flow rate control valve 61. Thus, the branched pipe B may be provided on the first coolant line 20 such that the fourth coolant line 50 and the cooling line 60 are connected. The coolant may flow to the cooling line 60 depending on opening/closing of the first flow rate control valve 61.

Thus, when the evaporator 14 absorbs heat in response to circulation of the refrigerant through the refrigerant circuit 10, the coolant flowing through the first heat exchanger 21 may be cooled. When the cooled coolant flows through the cooling line 60, air flowing through the interior may be cooled through the cold core 62, thereby supplying cooled air to the interior.

In addition, the fifth coolant line 70 branched from the front end and the rear end of the first heat exchanger 21 and connected to the first coolant line 20 through a fourth valve 71 is further included. A second exterior heat exchanger 72 and a fourth water pump 73 may be provided on the fifth coolant line 70.

The fifth coolant line 70 is branched from the first coolant line 20. The coolant circulating through the first coolant line 20 may selectively flow through the fifth coolant line 70 depending on opening/closing of the fourth valve 71. The fourth water pump 73 may be provided on the fifth coolant line 70 to obtain the flow rate of the coolant. The coolant may exchange heat with the ambient air through the second exterior heat exchanger 72.

As described above, the coolant cooled by heat exchange between the refrigerant and the coolant through the evaporator 14 of the refrigerant circuit 10 through the first heat exchanger 21 flows in the first coolant line 20, and the coolant heated by heat exchange between the refrigerant and the coolant through the condenser 12 of the refrigerant circuit 10 through the second heat exchanger 31 flows in the second coolant line 30. In addition, the coolant is controlled to selectively flow in the third coolant line 40, the fourth coolant line 50, and the fifth coolant line 70 by respective valves. Thus, not only temperatures of the battery 22 and the electronic component 51 may be managed but also the temperature of the coolant may be adjusted, so that the coolant may be efficiently managed.

In addition, a heating line 80 branched from the front end and the rear end of the second heat exchanger 31 and connected to the second coolant line 30 by a second flow rate control valve 81 is further included. A heater core 82 may be provided on the heating line 80.

The heating line 80 is provided for air conditioning of the interior. In this manner, air supplied to the interior may be heated by heat exchange with the coolant through the heater core 82.

The heating line 80 may be configured to be branched from the rear end of the second heat exchanger 31 of the second coolant line 30 and connected to the front end of the second heat exchanger 31. In addition, the second flow rate control valve 81 is provided on the heating line 80. Thus, the coolant may selectively flow through the heating line 80 in response to controlled opening/closing of the second flow rate control valve 81.

Consequently, when the condenser 12 dissipates heat in response to circulation of the refrigerant through the refrigerant circuit 10, the coolant flowing through the second heat exchanger 31 may be heated. When the heated coolant flows to the heating line 80, air flowing through the interior may be heated through the heater core 82, thereby supplying heating air to the interior.

Embodiments of the present invention may manage coolant depending on cooling/heating of the interior or temperature adjustment of the battery 22 using the above-described refrigerant and coolant circulation structures.

Specifically, as illustrated in FIG. 3, in a situation in which the mobility vehicle and the external thermal management station 100 are connected, in the case of cooling or heating the interior, the controller C may cause cooling coolant or heating coolant having entered through the inlet line no to flow through the heater core 82 and cause coolant having passed through the heater core 82 to circulate to the external thermal management station 100 through the outlet line 120 by controlling the first valve 23.

When the mobility vehicle and the external thermal management station 100 are connected, the mobility vehicle may be supplied with temperature-adjusted coolant through the external thermal management station boo. Thus, in the case of cooling or heating the interior, the controller C may adjust the temperature of conditioning air through the heater core 82 by causing coolant supplied by the external thermal management station 100 to flow through the heater core 82. Here, in the case of cooling the interior, cooled coolant may be supplied by the external thermal management station boo. In the case of heating the interior, heated coolant may be supplied by the external thermal management station 100.

As described above, in embodiments of the present invention, the inlet line no of the external thermal management station 100 and the heating line 80 on which the heater core 82 is provided are connected to the first valve 23. Thus, when cooling or heating conditioning air using coolant supplied by the external thermal management station 100, the temperature of the conditioning air may be adjusted by only operating the heater core 82.

In this manner, embodiments of the present invention may transfer cooling coolant or heating coolant supplied by the external thermal management station 100 to the heater core 82 to exchange heat with air flowing through the interior, thereby providing conditioning air having a temperature required for the interior.

The corresponding embodiment may be performed in a situation in which the charging of the battery 22 is completed and may be variously applied as required.

In addition, as illustrated in FIG. 4, in the case of cooling the battery 22, the controller C may cause coolant cooled through the first heat exchanger 21 to flow through the battery 22 by controlling the first valve 23.

In this manner, in the case of cooling the battery 22, the controller C causes coolant to circulate through the first coolant line 20 and controls the first valve 23 so that coolant circulates through the first heat exchanger 21 and the battery 22. Consequently, the battery 22 may be cooled by heat exchange with the coolant flowing through the first coolant line 20.

Here, the controller C may control the compressor 11 to operate depending on the temperature of the coolant circulating through the first coolant line 20 so that the coolant is cooled through the first heat exchanger 21.

In addition, as illustrated in FIG. 5, in the case of cooling the battery 22 in a situation in which the mobility vehicle and the external thermal management station 100 are connected, the controller C may cause coolant having entered through the inlet line no to flow through the battery 22 by controlling the first valve 23 and cause coolant having passed through the battery 22 to circulate to the external thermal management station 100 through the outlet line 120.

In this manner, when the mobility vehicle and the external thermal management station 100 are connected, temperature-adjusted coolant may be supplied through the external thermal management station 100. Consequently, when cooling the battery 22 in a situation in which the mobility vehicle and the external thermal management station 100 are connected, the controller C may cause the cooling coolant supplied by the external thermal management station 100 to flow through the battery 22, thereby cooling the battery 22.

In this manner, cooling coolant supplied to the external thermal management station 100 exchanges heat with the battery 22 and then circulates again to the external thermal management station 100 through the outlet line 120.

In addition, as illustrated in FIG. 6, in the case of cooling the battery 22, the controller C may cause refrigerant to circulate through the refrigerant circuit 10 by driving the compressor 11 and cause coolant cooled through the first heat exchanger 21 and cooling coolant having entered through the inlet line no to flow through the battery 22 by controlling the first valve 23.

That is, when only cooling coolant supplied by the external thermal management station 100 is determined to have insufficient cooling capacity to cool the battery 22, the controller C may compensate for the insufficient cooling capacity by causing refrigerant to circulate through the refrigerant circuit 10 of the mobility vehicle.

Here, the controller C may cause cooling coolant supplied by the thermal management station 100 to flow toward the battery 22 by controlling the first valve 23 and coolant cooled through the first heat exchanger 21 in the first coolant line 20 to flow toward the battery 22. Consequently, cooling coolant supplied by the external thermal management station 100 and coolant having passed through the first heat exchanger 21 join in the battery 22 to obtain the cooling capacity required, thereby improving cooling efficiency of the battery 22.

In this manner, a portion of coolant having passed through the battery 22 may be recirculated to the external thermal management station 100 through the outlet line 120, whereas the remaining portion of the same coolant may be recirculated to the first coolant line 20 to exchange heat again with the first heat exchanger 21.

In addition, for management of refrigerant in the refrigerant circuit 10, the controller C may cause refrigerant to condense by heat exchange between refrigerant and coolant through the condenser 12 and the second heat exchanger 31 and cause coolant heated during passing through the second heat exchanger 31 to be cooled through the radiator 42 in the third coolant line 40 by controlling the second valve 41. In addition, it is apparent that the first flow rate control valve 61 and the fourth valve 71 may be on/off controlled according to the flow of the coolant as described above and such on/off control is only illustrated in the figures. The first flow rate control valve 61 and the second flow rate control valve 81 may also be controlled depending on whether or not the temperature of the interior is adjusted.

As described above, embodiments of the present invention may obtain cooling capacity of the battery 22 using the external thermal management station 100 and the circulation of refrigerant.

In addition, as illustrated in FIG. 7, in the case of heating the battery 22, the controller C may cause refrigerant to circulate through the refrigerant circuit 10 by driving the compressor 11 and cause coolant heated through the second heat exchanger 31 to flow through the battery 22 by controlling the first valve 23.

In this manner, in the case of heating the battery 22, the controller C may cause coolant to circulate through the second coolant line 30 and cause coolant to circulate through the second heat exchanger 31 and the battery 22 by controlling the first valve 23.

Here, the controller C may cause coolant to be heated through the second heat exchanger 31 by driving the compressor 11 depending on the temperature of the coolant circulating through the second coolant line 30.

In addition, as illustrated in FIG. 5, in the case of heating the battery 22 in a situation in which the mobility vehicle and the external thermal management station 100 are connected, the controller C may cause heating coolant having entered through the inlet line no to flow through the battery 22 by controlling the first valve 23 and cause coolant having passed through the battery 22 to circulate through the external thermal management station 100 through the outlet line 120.

As described above, in a situation in which the mobility vehicle and the external thermal management station 100 are connected, temperature-adjusted coolant may be supplied through the external thermal management station 100. Consequently, in the case of heating the battery 22 in a situation in which the mobility vehicle and the external thermal management station 100 are connected, the controller C may cause heating coolant supplied by the external thermal management station 100 to flow to the battery 22, thereby increasing the temperature of the battery 22.

In this manner, heating coolant supplied by the external thermal management station 100 exchanges heat with the battery 22 and then circulates again to the external thermal management station 100 through the outlet line 120.

In addition, as illustrated in FIG. 8, in the case of heating the battery 22, the controller C may cause refrigerant to circulate through the refrigerant circuit 10 by driving the compressor 11 and cause coolant heated through the second heat exchanger 31 and heating coolant having entered through the inlet line no to flow through the battery 22 by controlling the first valve 23.

That is, when only heating coolant supplied by the external thermal management station 100 is determined to have insufficient heating capacity to heat the battery 22, the controller C may cause refrigerant to circulate through the refrigerant circuit 10 provided in the mobility vehicle, thereby compensating for insufficient heating capacity.

Here, the controller C may cause heating coolant provided by the external thermal management station 100 to flow toward the battery 22 by controlling the first valve 23 and cause coolant cooled through the second heat exchanger 31 in the second coolant line 30 to flow toward the battery 22. Consequently, heating coolant supplied by the external thermal management station 100 and coolant having passed through the second heat exchanger 31 may join in the battery 22, thereby improving heating efficiency of the battery 22.

In this manner, a portion of the coolant having passed through the battery 22 may recirculate to the external thermal management station 100 through the outlet line 120, whereas the remaining portion of the same may recirculate through the second coolant line 30 to exchange heat again with the second heat exchanger 31.

In addition, for management of the refrigerant in the refrigerant circuit 10, the controller C may cause the refrigerant to evaporate by heat exchange between the refrigerant and the coolant through the evaporator 14 and the first heat exchanger 21 and cause the temperature of the coolant heated during passing through the first heat exchanger 21 to be adjusted by heat exchange through the second exterior heat exchanger 72 in the fifth coolant line 70. In addition, the first flow rate control valve 61 and the second flow rate control valve 81 may be on/off adjusted depending on the flow of the coolant as described above and the direction of opening/closing may be converted depending on whether or not the temperature of the interior is adjusted.

As described above, embodiments of the present invention may obtain heating capacity of the battery 22 using the external thermal management station 100 and the circulation of the refrigerant.

The coolant management system for a mobility vehicle having the above-described structure may cause coolant managed outside an electric vehicle to be shared with coolant circulating through the battery 22 provided in the electric vehicle for thermal management of the battery of the electric vehicle, thereby improving charging efficiency of the battery 22 through temperature management of the battery when charging the battery 22. That is, it is possible to optimize temperature management of the battery according to the situation by efficient management of the coolant circulating through the battery 22 and the coolant managed outside the vehicle.

In addition, since it is possible to perform cooling or heating to the interior of the vehicle using coolant managed outside the vehicle, the efficiency of air conditioning energy of the mobility vehicle may be obtained.

Although the exemplary embodiments of the present invention have been described for illustrative purposes, those skilled in the art will appreciate that various modifications, additions, and substitutions are possible, without departing from the scope and spirit of the present invention as disclosed in the accompanying claims.

What is claimed is:

1. A coolant management system for a mobility vehicle, the coolant management system comprising:
an inlet line and an outlet line configured to be connected to an external thermal management station and configured to selectively supply a cooling coolant or a heating coolant;
a refrigerant circuit provided in the mobility vehicle and configured to circulate a refrigerant therethrough, the refrigerant circuit comprising a compressor, a condenser, an expander, and an evaporator;
a first coolant line, wherein a battery and a first heat exchanger configured to exchange heat with the evaporator of the refrigerant circuit are provided on the first coolant line, and wherein the inlet line is connected to a front end of the battery through a first valve and the outlet line is connected to a rear end of the battery;
a second coolant line, wherein a second heat exchanger configured to exchange heat with the condenser of the refrigerant circuit is provided on the second coolant line, wherein the outlet line and the first coolant line are connected to a front end of the second heat exchanger, and wherein the first coolant line is connected to a rear end of the second heat exchanger through the first valve; and
a controller configured to communicate with the external thermal management station and control respective valves to manage a temperature of coolant in the first and second coolant lines.

2. The coolant management system of claim 1, further comprising:
a first water pump provided on the first coolant line; and
a second water pump provided on the second coolant line.

3. The coolant management system of claim 2, further comprising a coolant heater on the second coolant line.

4. The coolant management system of claim 1, further comprising on/off valves provided on the inlet line and the outlet line, respectively, wherein the controller is configured to on/off control each of the on/off valves.

5. The coolant management system of claim 1, further comprising:
a third coolant line branched from the front end and the rear end of the second heat exchanger and connected to the second coolant line through a second valve; and
a radiator provided on the third coolant line.

6. The coolant management system of claim 1, further comprising:
a fourth coolant line branched from a front end and a rear end of the first heat exchanger and connected to the first coolant line; and
an electronic component, a first exterior heat exchanger, and a third water pump provided on the fourth coolant line.

7. The coolant management system of claim 6, wherein:
the fourth coolant line is disposed such that the electronic component and the first exterior heat exchanger are branched; and
a third valve is provided at a branch point.

8. The coolant management system of claim 1, further comprising:
a cooling line branched from the first heat exchanger of the first coolant line and connected to the first coolant line through a first flow rate control valve; and
a cold core provided on the cooling line.

9. The coolant management system of claim 1, further comprising:
a fifth coolant line branched from a front end and a rear end of the first heat exchanger and connected to the first coolant line through a fourth valve; and
a second exterior heat exchanger and a fourth water pump provided on the fifth coolant line.

10. The coolant management system of claim 1, further comprising:
a heating line branched from the front end and the rear end of the second heat exchanger and connected to the second coolant line by a second flow rate control valve; and
a heater core provided on the heating line.

11. The coolant management system of claim 10, wherein in a situation in which the mobility vehicle and the external thermal management station are connected, in a case of cooling or heating an interior of the mobility vehicle, the controller is configured to cause the cooling coolant or the heating coolant having entered through the inlet line to flow through the heater core and cause the coolant having passed through the heater core to circulate to the external thermal management station through the outlet line by controlling the first valve.

12. The coolant management system of claim 1, wherein in a case of cooling the battery, the controller is configured to cause the refrigerant to circulate through the refrigerant circuit by driving the compressor and cause the coolant cooled through the first heat exchanger and the cooling coolant having entered through the inlet line to flow through the battery by controlling the first valve.

13. The coolant management system of claim 1, wherein in a case of cooling the battery in a situation in which the mobility vehicle and the external thermal management station are connected, the controller is configured to cause the cooling coolant having entered through the inlet line to flow through the battery by controlling the first valve and cause the coolant having passed through the battery to circulate to the external thermal management station through the outlet line.

14. The coolant management system of claim 13, wherein in a case of cooling the battery, the controller is configured to cause the refrigerant to circulate through the refrigerant circuit by driving the compressor and cause the coolant cooled through the first heat exchanger and the cooling coolant having entered through the inlet line to flow through the battery by controlling the first valve.

15. The coolant management system of claim 1, wherein in a case of heating the battery, the controller is configured to cause the refrigerant to circulate through the refrigerant circuit by driving the compressor and cause the coolant heated through the second heat exchanger to flow through the battery by controlling the first valve.

16. The coolant management system of claim 1, wherein in a case of heating the battery in a situation in which the mobility vehicle and the external thermal management station are connected, the controller is configured to cause the heating coolant having entered through the inlet line to flow through the battery by controlling the first valve and cause the coolant having passed through the battery to circulate to the external thermal management station through the outlet line.

17. The coolant management system of claim 16, wherein in a case of heating the battery, the controller is configured to cause the refrigerant to circulate through the refrigerant circuit by driving the compressor and cause the coolant heated through the second heat exchanger and the heating coolant having entered through the inlet line to flow through the battery by controlling the first valve.

18. A coolant management system for a mobility vehicle, the coolant management system comprising:
an external thermal management station configured to selectively supply a cooling coolant or a heating coolant, the external thermal management station comprising:
a first storage tank in which the heating coolant is stored;
a second storage tank in which the cooling coolant is stored; and
a thermal management circuit comprising a thermal management compressor, a thermal management condenser disposed inside the first storage tank, a thermal management expander, and a thermal management evaporator disposed inside the second storage tank; and
an inlet line and an outlet line connected to the external thermal management station, wherein the inlet line and the outlet line extend from the first storage tank and the second storage tank, respectively, and are provided with on/off valves, respectively;
a refrigerant circuit provided in the mobility vehicle and configured to circulate a refrigerant therethrough, the refrigerant circuit comprising a compressor, a condenser, an expander, and an evaporator;
a first coolant line configured to circulate a coolant therethrough, wherein a battery and a first heat exchanger configured to exchange heat with the evaporator of the refrigerant circuit are provided on the first coolant line, and wherein the inlet line is connected to a front end of the battery through a first valve and the outlet line is connected to a rear end of the battery;
a second coolant line configured to circulate the coolant therethrough, wherein a second heat exchanger configured to exchange heat with the condenser of the refrigerant circuit is provided on the second coolant line, wherein the outlet line and the first coolant line are connected to a front end of the second heat exchanger, and wherein the first coolant line is connected to a rear end of the second heat exchanger through the first valve; and
a controller configured to communicate with the external thermal management station and control respective valves to manage a temperature of the coolant.

19. The coolant management system of claim 18, further comprising an additional condenser provided on the thermal management circuit between the thermal management compressor and the thermal management condenser, wherein the refrigerant can flow through the additional condenser based on opening/closing of an additional valve.
